(19) United States
(12) Patent Application Publication
(10) Pub. No.: US 2005/0252998 A1
(43) Pub. Date: Nov. 17, 2005

(54) Opening means

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/844,179

(22) Filed: May 11, 2004

(51) Int. Cl. B65D 41/32; B31C 11/04; B05B 15/00; B05B 1/26

(52) U.S. Cl. 239/542; 239/544; 239/545

(57) ABSTRACT

An improved opening means for plastic tubular containers in the form of score lines that will minimize the exposed sharp edge at the fracture surface and retain the separated sections of the plastic tube together. The opening means comprises of one or more sections of score lines in the form of arcs around the circumference of a plastic tube. None of the score lines are formed around the entire circumference of the plastic tube. Each score line terminates at a rounded terminal at each end of the arc to eliminate tension concentration and limit propagation of the fracture upon bending of the plastic tube at the score lines.

### FIELD OF INVENTION

The present invention relates generally to an opening means for a plastic tube. More specifically, the present invention relates to an opening means in the form of an improved line or score line on a plastic tube.

### RELATED ART

Opening means in the form of a score line are commonly used to open small plastic containers such as an elongated plastic tubular container. The score line forms a weakened section the plastic tube to allow fracturing of the plastic tube at the score line. The score line may be formed by various methods such as by a shallow cut around the entire circumference of the plastic tube that does not penetrate the wall thickness of the plastic tube. The score line allows the small container such as an elongated plastic tube to be opened by simply bending and snapping apart the plastic tube at the score line. The plastic tube will break apart at the score line into two sections. The broken end of each section has a relatively sharp edge. When the score line is formed near one end of the plastic tube, after the two sections are separated, the smaller section tends to get lost due to its small size and are hard to locate and retain.

### SUMMARY OF THE INVENTION

The present invention is an improved opening means for plastic tubular containers. The opening means is an improved score line that will minimize the exposed sharp edge at the fracture surface and retain the separated sections of the plastic tube together. The opening means comprises of one or more score lines in the form of arcs around the circumference of a plastic tube. There are two score lines positioned generally opposite to each other around the circumference of the plastic tube in the preferred embodiment of the opening means. None of the score lines are formed around the entire circumference of the plastic tube. Each score line terminates at a rounded terminal at each end of the arc to eliminate tension concentration and limit propagation of the fracture upon bending of the plastic tube at the score lines. The score lines may be formed with a hot blade, an ultrasound blade, or any other suitable means.

### DESCRIPTION OF THE DRAWINGS

FIG. 1 shows a perspective view of the preferred embodiment of the opening means.

FIG. 2 shows a perspective view of the preferred embodiment of the opening means shown in FIG. 1 rotated 90 degrees axially.

FIG. 3 shows an end view of the preferred embodiment of the opening means.

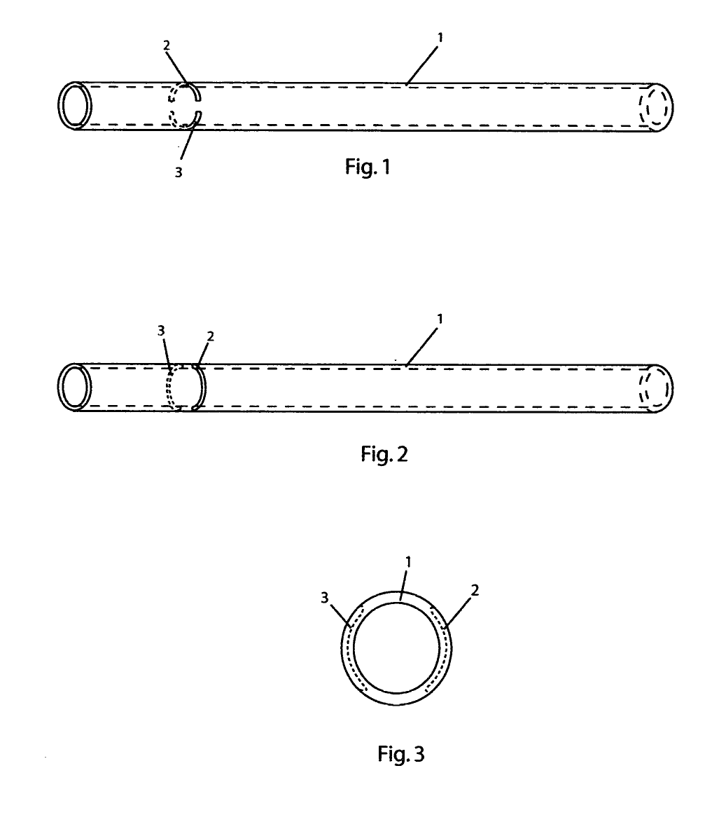

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

The present invention is an improved opening means for plastic tubular containers. The opening means is an improved score line that will minimize the exposed sharp edge at the fracture surface and retain the separated sections of the plastic tube together.

The opening means comprises of one or more score lines 2, 3 in the form of arcs around the circumference of a plastic tube 1. There are two score lines 2, 3 positioned generally opposite to each other around the circumference of the plastic tube 1 with a short distance between them in the preferred embodiment of the opening means. None of the score lines 2, 3 are formed around the entire circumference of the plastic tube 1. Each score line 2, 3 terminates at a rounded terminal at each end of the arc to eliminate tension concentration and limit propagation of the fracture upon bending of the plastic tube 1 at the score lines 2, 3. The remaining material of the plastic tube 1 between the score lines 2, 3 will retain the separated sections of the plastic tube 1 together after fracture of the score lines 2, 3 and minimize the exposure of the sharp edge at the fracture surface.

The score lines 2, 3 may be formed with a hot blade, an ultrasound blade, or any other suitable means. With a hot blade, the score lines 2, 3 are essentially melted into the plastic tube 1. Due to the heat of the hot blade, the plastic tube will melt away from the hot blade to form the score lines 2, 3. The score lines 2, 3 formed with the hot blade will have a rounded contour at the bottom of the score lines 2, 3 as well as at both ends of the arc. This rounding of the contour of the score line will eliminate tension concentration and limit propagation of the fracture upon bending of the plastic tube 1 at the score lines 2, 3. With an ultrasound blade, a similar form of score line 2, 3 will be formed. The ultrasound essentially melts the plastic tube 1 in a similar fashion as the hot blade.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An opening means comprising one or more score lines in the form of arcs around the circumference of a plastic tube without being formed around the entire circumference of the plastic tube.

2. An opening means as in claim 1, wherein two score lines in the form of arcs are formed around the circumference of said plastic tube without being formed around the entire circumference of the plastic tube.

3. An opening means as in claim 1, wherein said one or more score lines each terminate at a rounded terminal at each end of the arc to eliminate tension concentration and limit propagation of the fracture upon bending of the plastic tube at the score lines.

4. An opening means as in claim 2, wherein said two score lines each terminate at a rounded terminal at each end of the arc to eliminate tension concentration and limit propagation of the fracture upon bending of the plastic tube at the score lines.

5. An opening means as in claim 3, wherein said one or more score lines are formed with a heated blade.

6. An opening means as in claim 3, wherein said one or more score lines are formed with an ultrasound blade.

7. An opening means as in claim 4, wherein said one or more score lines are formed with a heated blade.

8. An opening means as in claim 4, wherein said one or more score lines are formed with an ultrasound blade.
